(19) United States
(12) Patent Application Publication
(10) Pub. No.: US 2020/0124213 A1
(43) Pub. Date: Apr. 23, 2020

(54) BEARING ARRANGEMENT FOR FIREFIGHTING MONITOR

(71) Applicant: Elkhart Brass Manufacturing Company, Inc., Elkhart, IN (US)

(72) Inventors: Brian W. Exner, South Bend, IN (US); Martin J. Moran, Elkhart, IN (US)

(21) Appl. No.: 16/596,895

(22) Filed: Oct. 9, 2019

Related U.S. Application Data
(60) Provisional application No. 62/746,773, filed on Oct. 17, 2018.

(51) Int. Cl. F16L 27/08; A62C 33/04

(52) U.S. Cl. CPC F16L 27/0841; A62C 33/04

(57) ABSTRACT

A firefighting monitor that has a first section, a second section joined to the first section by a first pivot connection, and a plurality of ball bearings positioned in the first pivot connection between a pair of bearing seats. Wherein, the bearing seats define an arc of contact with each of the plurality of ball bearings, the center of the arc of contact defining a tangent angled with respect to a flow axis defined by the first pivot connection.

### CROSS REFERENCE TO RELATED APPLICATIONS

The present disclosure claims the benefit of U.S. Provisional Application No. 62/746,773 filed on Oct. 17, 2018, the contents of which are hereby incorporated herein in entirety.

### FIELD OF THE DISCLOSURE

The present disclosure relates to firefighting monitors, and, in particular, to a bearing arrangement for pivotable firefighting monitors.

### BACKGROUND OF THE DISCLOSURE

Firefighting monitors are used to discharge water or other firefighting fluids from a large and/or fixed mounting platform such as a fire truck, aerial ladder, or stationary monitor support. Firefighting monitors may be pivotable about vertical and horizontal axes so that the discharge nozzle of the monitor can be directed at any location along a left-to-right angular sweep and a high-to-low elevational sweep.

### SUMMARY OF THE DISCLOSURE

The present disclosure provides a pivotable firefighting monitor with an enhanced bearing arrangement in the pivot connections. In particular, the pivot connections include ball bearings seated in races defined by opposed bearing seats. Each bearing seat is configured to support bearing forces with a reaction force that is angled relative to the flow axis, such that the reaction force vector includes substantial axial and radial force vector components. These twin vector components capably handle both axial and radial forces which may be generated by operation of the pivot connections of the monitor and by fluid flow through the monitor.

One embodiment is a firefighting monitor that has a first section, a second section joined to the first section by a first pivot connection, and a plurality of ball bearings positioned in the first pivot connection between a pair of bearing seats. Wherein, the bearing seats define an arc of contact with each of the plurality of ball bearings, the center of the arc of contact defining a tangent angled with respect to a flow axis defined by the first pivot connection.

One example of this embodiment has a third section joined to the second section by a second pivot connection. In one aspect of this example, the first pivot connection defines a first pivot axis, and the second pivot connection defines a second pivot axis substantially perpendicular to the first pivot axis. Another aspect of this example has a second plurality of ball bearings disposed between a pair of bearing seats of the second pivot connection, the bearing seats defining an arc of contact with each of the second plurality of ball bearings, the center of the arc of contact defining a tangent angled with respect to a flow axis defined by the second pivot connection.

Another embodiment is a pivoting joint for conduit. The pivoting joint has a first section defining a flow path for a fluid along an axis and a first bearing seat defined around the axis, a second section defining a flow path for a fluid along the axis and a second bearing seat defined around the axis, and a first bearing positioned between the first bearing seat and the second bearing seat. Wherein, the first bearing directly contacts the first section and second section.

In one example of this embodiment, the first bearing is a ball bearing. In another example, the first section is an inlet to a firefighting monitor and the second section is an intermediate section of the firefighting monitor.

In yet another example of this embodiment the pivoting joint has a retainer removably coupled to the first section, a third bearing seat defined in the second section, a fourth bearing seat defined in the retainer and a second bearing positioned between the third bearing seat and the fourth bearing seat. In one aspect of this example, the second bearing directly contacts the third bearing seat and the fourth bearing seat. In another aspect of this example, the first bearing seat is formed of the same material as the first section.

Another aspect of this example has a first seal channel defined in the first section with a first seal positioned therein and a second seal channel defined in the retainer with a second seal positioned therein. In part of this aspect, the first seal fluidly seals the first bearing from the flow path and the second seal substantially prevents debris from contacting the second bearing.

Yet another example has a seal channel defined in the first section and a seal positioned therein. In one aspect of this example, the seal fluidly seals the first bearing from the flow path.

In another example, the second section contains a subsection that is removable from the second section. In one aspect of this example, the second bearing seat is defined in the subsection. Yet another example of this embodiment has a locking mechanism that selectively locks rotation of the second section relative to the first section.

Another embodiment of this disclosure is a method of assembling ball bearings of a firefighting monitor. The method includes providing a first section of conduit, a second section of conduit, a retainer, and a plurality of ball bearings, positioning the plurality of ball bearings along a first bearing seat defined in the first section of conduit, axially aligning the second section of conduit with the first section of conduit, sliding a portion of the second section of conduit into the first section of conduit until a second bearing seat defined in the second section of conduit contacts the plurality of bearings and coupling the retainer to the first section of conduit to substantially axially lock the second section of conduit to the first section of conduit. Wherein, when the retainer is coupled to the first section of conduit the second section of conduit rotates relative to the first section of conduit.

One example of this embodiment includes positioning a first O-ring between the first section of conduit and the second section of conduit to fluidly seal the plurality of bearings from a flow path defined through the first and second section of conduit. One aspect of this example includes positioning a second O-ring between the retainer and the second section of conduit.

### BRIEF DESCRIPTION OF THE DRAWINGS

The above-mentioned and other features of the disclosure and the manner of obtaining them will become more apparent and the disclosure itself will be better understood by reference to the following description of exemplary embodiments of the disclosure taken in conjunction with the accompanying drawings.

FIG. 1 is a perspective view of a firefighting monitor made in accordance with the present disclosure;

FIG. 2 is an elevation, partial section view of the firefighting monitor shown in FIG. 1, illustrating components of upstream and downstream pivot connections;

FIG. 3 is an enlarged elevation, cross-section view of a portion of FIG. 2, illustrating the downstream pivot connection;

FIG. 4 is an elevation, cross-section, exploded view of the downstream pivot connection shown in FIG. 3;

FIG. 5 is an enlarged view of a portion of FIG. 3, illustrating components of a bearing arrangement made in accordance with the present disclosure;

FIG. 6 is an elevated perspective view of another embodiment of a pivot connection; and

FIG. 7 is an enlarged partial section view of the pivot connection of FIG. 6.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the disclosure, and such exemplifications are not to be construed as limiting the scope of the disclosure in any manner.

### DETAILED DESCRIPTION OF THE DRAWINGS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

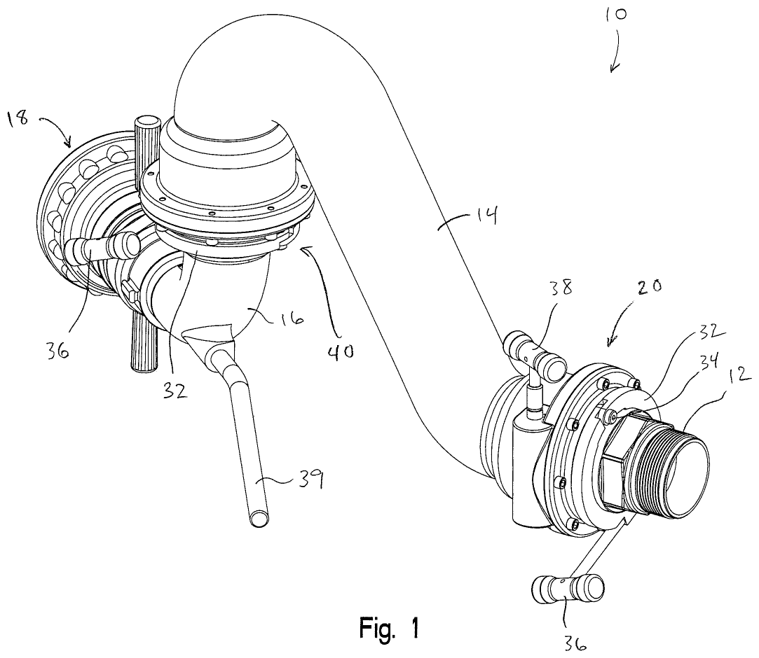

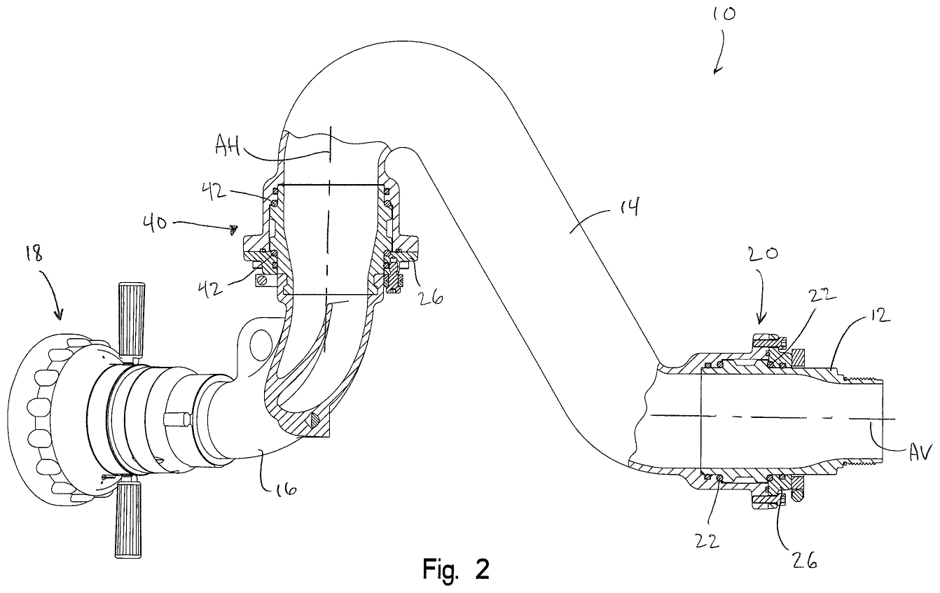

FIG. 1 illustrates monitor 10 having inlet section 12, intermediate section 14 pivotably connected to inlet section 12 via upstream pivot connection 20, and outlet section 16 pivotably connected to intermediate section 14 via downstream pivot connection 40. In some applications, monitor 10 may be fixed to a mounting surface via a threaded connection between inlet section 12 and a base (not shown) fixed to the mounting surface. Inlet 12 may receive a flow of water or other firefighting fluid and direct the flow to intermediate and outlet sections 14, 16, then to nozzle 18 to direct an outlet flow in a desired direction. In one exemplary embodiment, monitor 10 may be configured to receive, direct and discharge relatively large flows of water or other firefighting fluid, such as up to 250, 350, 500, 700 or 1000 gallons per minute at water pressures of between 40 and 150 psi. For example, embodiments of monitor 10 may be capable of receiving, redirecting and discharging between 350 and 1000 gallons per minute at 75 psi, with higher or lower discharge capacities being generally proportional to higher or lower input fluid pressures respectively. Further still, in other embodiments the monitor 10 may be capable of receiving, redirecting, and discharging more than 1000 gallons per minute. In one non-exclusive example, the monitor 10 can process more than 2000 gallons per minute. In yet another example, the monitor can process over 5000 gallons per minute. Accordingly, this disclosure contemplates many different flow rates for the monitor 10.

Where monitor 10 is fixed to a horizontal mounting surface, upstream pivot connection 20 swivels intermediate section 14, outlet section 16 and nozzle 18 about vertical axis AV (FIG. 2). The vertical flow path at inlet 12 is redirected by intermediate section 14 to a horizontal flow path leading to outlet section 16, such that downstream pivot connection 40 is capable of pivoting outlet section 16 and nozzle 18 about a horizontal axis AH. In use, upstream pivot connection 20 allows nozzle 18 to be pivoted through an angular sweep of up to 360° around vertical axis AV, while downstream pivot connection 40 allows nozzle 18 to be pivoted up or down relative to the horizontal mounting surface through an elevational sweep of up to, or in some cases more than, 180°. Of course, monitor 10 may also be mounted to other mounting surface configurations, such as vertical mounting surfaces, with attendant changes in the relative potential positions of nozzle 18 resulting from adjustment of upstream and downstream pivot connections 20 and 40.

As shown in FIG. 2 and described in detail below, upstream and downstream pivot connections 20 and 40 have an arrangement of ball bearings 22 and 42, respectively, which cooperate with their adjacent bearing seats to absorb and distribute both axial forces, i.e., forces generated along the direction of flow through a respective connection 20, 40, as well as radial forces, i.e., forces perpendicular to the flow axis. For purposes of the following discussion, downstream pivot connection 40 will be shown and described in detail, it being understood that upstream pivot connection 20 may be identical or similarly constructed. In the illustrated embodiment, downstream connection 40 is similar in structure and function to upstream connection 20, and reference numerals of downstream connection 40 are analogous to reference numerals used in upstream connection 20, except with 20 added thereto.

While ball bearings are discussed herein, this disclosure also contemplates utilizing other geometries for the bearings as well. More specifically, the bearings may be cylindrical or frustoconical in shape. In this embodiments, the bearing seats may correspond with the shape of the bearing to implement the advantages discussed herein. In yet another embodiment, the bearing may be formed of a continuous material such as a ring or the like positioned between the bearing seats. The continuous material of the bearing for this embodiment may be formed of a friction reducing material to thereby allow the bearing seats to move relative to one another over the continuous material bearing.

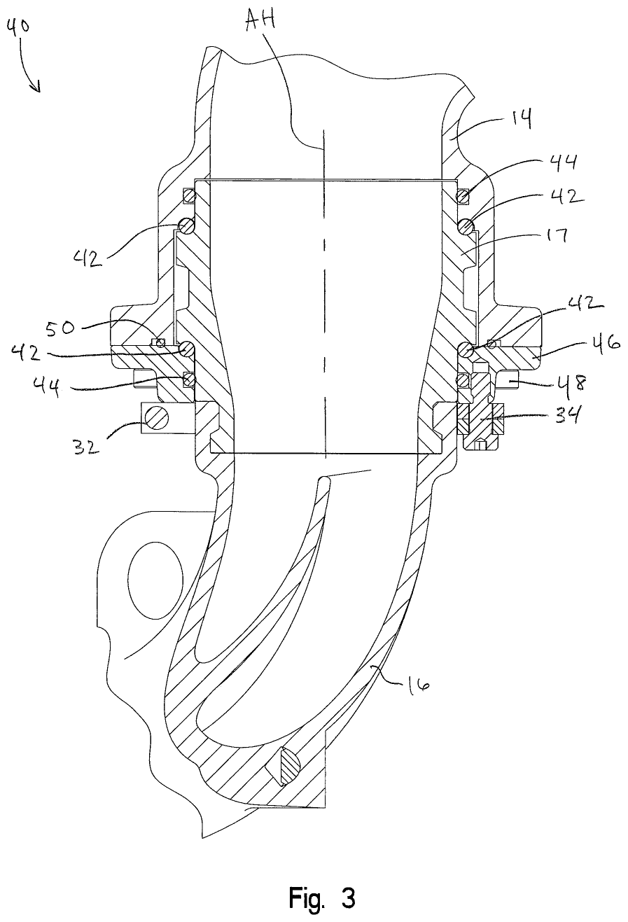

Turning now to FIG. 3, downstream pivot connection 40 is shown in detail. As noted above, outlet section 16 is rotatably received within intermediate section 14. In the illustrated embodiment, outlet subsection 17 is received within intermediate section 14 and fixed to outlet section 16. For purposes of the present discussion, outlet subsection 17 and outlet section 16 and may be considered to be joined as an integral whole. Moreover, in upstream pivot connection 20 shown in FIG. 2, a monolithic inlet section 12 is similarly received within the opposite end of intermediate section 14 in the same manner as the integral whole formed by outlet section 16 and outlet subsection 17.

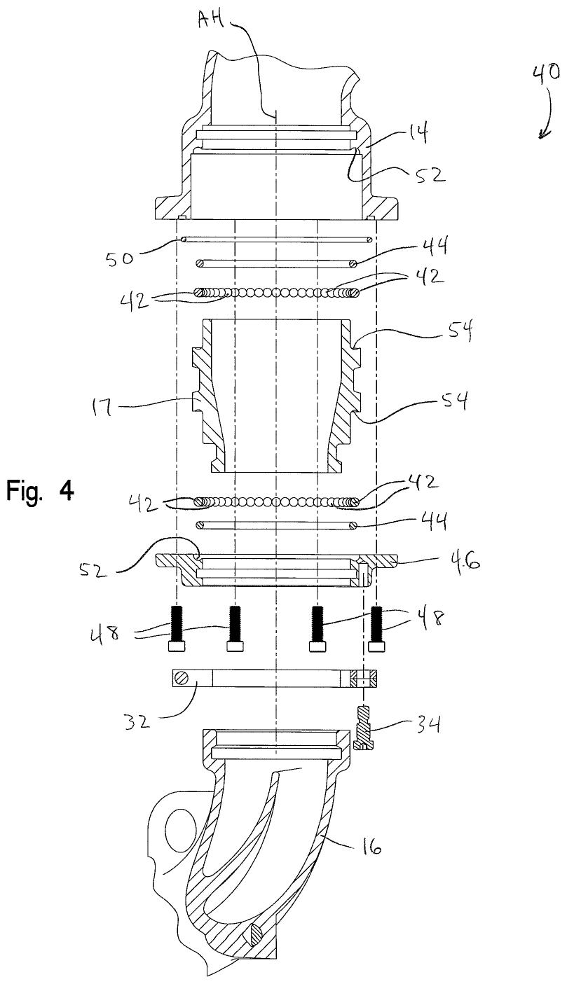

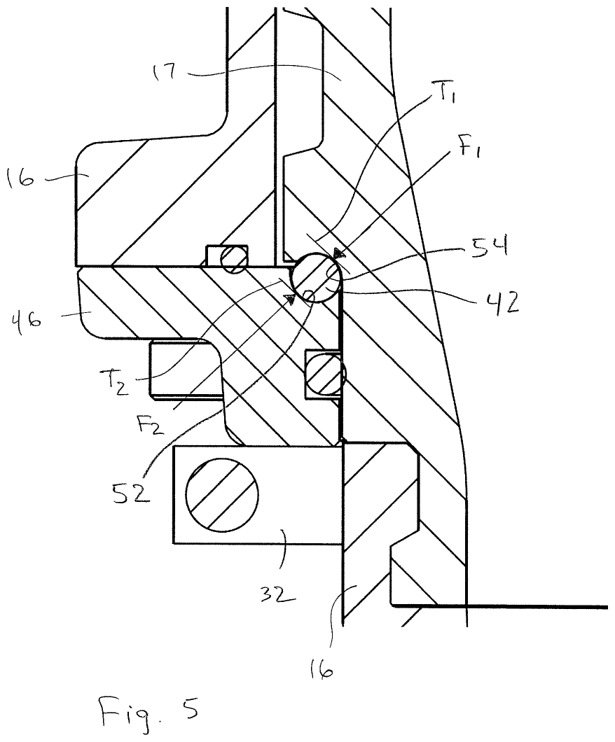

An upstream set of ball bearings 42 is received within a bearing race formed between outlet subsection 17 and intermediate section 14. In particular, intermediate section 14 has an outboard bearing seat 52, shown in FIGS. 4 and 5, while intermediate subsection 17 includes a corresponding inboard bearing seat 54. When outlet subsection 17 is seated within intermediate section 14, bearings 42 become captured between outboard and inboard seats 52, 54. Together with bearing grease or other lubricant packed into the bearing race, bearings 42 facilitate smooth rotation of outlet subsection 17 with respect to intermediate section 14. Similarly, a downstream set of ball bearings 42 engages a downstream, inboard bearing seat 54 formed on outlet subsection 17, and becomes captured by a downstream, outboard bearing seat 52 formed on retainer 46. Retainer 46 is fixed to intermediate section 14 via a set of retainer bolts 48.

As best seen in FIG. 5 with respect to the downstream set of ball bearings 42 for pivot connection 40, the outboard and inboard bearing seats 52, 54 capture ball bearings 42 in a way that produces reaction forces F₁ and F₂ to loads exerted by bearings 42 on bearing seats 52 and 54. These reaction forces F₁ and F₂ are skewed from both the axial and radial directions, defining the illustrated angle of about 45° with respect to the nearby flow axis. In particular, the center of the arc of contact between a given bearing 42 and inboard bearing seat 54 forms a tangent T₁ which is oriented about 45° from the nearby flow axis (in the embodiment of FIGS. 3 and 5, horizontal axis AH). Therefore, the vector created by reaction force F₁, which is exerted by inboard bearing seat 54 upon bearing 42 during operation of monitor 10, also forms an angle of about 45° with the nearby flow axis. A similar arrangement is found at the other side of the bearing seat, i.e., outboard bearing seat 52 forms tangent T₂ and reaction force F₂ which are both angled about 45° with respect to the nearby flow axis.

In the illustrated embodiment of FIG. 5, this angled bearing seat arrangement may be formed by forming bearing seats 52, 54 in what would otherwise be “corners” between radial and axial surfaces of the associated structure. For example, referring to FIG. 5, outboard bearing seat 52 generally extends in an arc starting at a radial surface of retainer 46 (i.e., the surface which abuts outlet section 16) and an axial surface thereof (i.e., the cylindrical surface facing radially inwardly toward outlet subsection 17). Thus, outboard bearing seat 52 is formed in what would otherwise be an “outside corner” of retainer 46. Similarly, inboard bearing seat 54 generally extends from a radially extending surface to an axially extending surface along what would otherwise be an “inside corner” of outlet subsection 17.

The illustrated arrangement of bearings 42 and the associated bearing seats 52, 54 allows the angled reaction force vectors F₁ and F₂ to effectively distribute both axial and radial forces generated by operation of monitor 10, including forces arising from the weight of the monitor components, redirection of pressurized fluid flows through monitor 10, and various external forces which may be exerted upon monitor 10 in the course of service (such as forces generated by operator manipulation). For example, a substantial axial force vector is created by pressurized fluid flow through downstream pivot connection 40. This axial force urges the downstream bearing seats 52, 54 toward one another and thereby places an axial compression upon the downstream set of bearings 42. This axial force is borne by the axial vector component of the angled force vectors F₁ and F₂. Meanwhile, radial forces may also be present from the weight of monitor components, such as nozzle 18 (FIG. 1), forces exerted by the user of monitor 10 upon its exterior during the course of operation, etc. These radial forces are borne by the radial component of angled reaction forces F₁ and F₂. Moreover, the arc of contact between bearings 42 and bearing seats 52, 54 extends up to 90 degrees from the center point of reaction force F₁ and F₂ (shown in FIG. 5, and also the point from which tangents T₁, T₂ are taken). This arc of contact centered ensures that dynamic radial and axial loads placed upon bearings 42 by monitor 10 can be effectively borne without undue stress concentrations which might otherwise result from loads borne by the edge of a “non-angled” bearing seat.

The other sets of ball bearings 22, 42 engage their receptive bearing seats with similar force dispersal dynamics as described above with respect to the downstream set of ball bearings 42 and downstream pivot connection 40.

Turning to FIGS. 3 and 4, downstream pivot connection 40 further includes O-ring 44 which creates a fluid-tight seal between intermediate section 14 and outlet subsection 17, thereby preventing any of the pressurized firefighting fluid passing there through from reaching bearings 42 or otherwise leaking out of monitor 10. In some instances, O-ring 44 may need replacement or inspection, such as after normal wear resulting from use and operation of monitor 10. Similarly, bearings 42 may sometimes need to be replaced or inspected, or have their grease or other lubricant replaced. In order to facilitate access to bearings 42 and O-ring 44, retainer bolts 48 may be removed from retainer 46 thereby allowing outlet subsection 17 and retainer 46 to be disconnected from intermediate section 14. Separation of outlet subsection 17 from retainer 46 exposes the downstream set of bearings 42, allowing inspection, service and/or replacement of the entire set of bearings 42 simultaneously. Similarly, withdrawal of outlet subsection 17 from intermediate section 14 exposes the upstream set of bearings 42, as well as O-ring 44. These components can then be inspected, serviced and/or replaced as needed. When the required maintenance and/or repair is complete, the assembly can be reassembled efficiently and quickly by simply re-seating outlet subsection 17 within intermediate section 14, and replacing retainer 46 and retainer bolts 48.

Turning again to FIG. 3, a second O-ring 44 may be provided between the retainer 46 and outlet subsection 17, as shown. O-ring 44 keeps dust and dirt or other contaminants from the ambient area around monitor 10 from contaminating bearings 42 or any other internal structures at the rotatable junction between outlet section 16 and intermediate section 14. A further compression seal 50 may be provided in the interface between retainer 46 and intermediate section 14. O-ring 44 and seal 50 are also easy to inspect, repair and/or replace by removal of retainer 46 as described above.

As best seen in FIG. 1, swivel lock 32 may be provided at upstream pivot connection 20 and downstream pivot connection 40. As shown, swivel lock 32 has two arms pivotally joined to one another via pivot bolt 34. These two arms are configured to be compressed upon the adjacent outer surface of inlet section 12 or outlet section 16 via adjustment of lock handle 36. Referring to FIG. 3, pivot bolt 34 may be threadably received within an aperture formed in retainer 46, such that swivel lock 32 is rotatably fixed to intermediate section 14 via retainer 46. Swivel lock 32 can be used to rotatably fix inlet section 12 or outlet section 16 to intermediate section 14. In particular, as lock handle 36 is tightened, a high amount of friction is created between the interior arcuate surface of swivel lock 32 and the adjacent, correspondingly arcuate exterior surface of either inlet 12 or outlet 16. This frictional interaction effectively locks the inlet section 12 or outlet section 16 to intermediate section 14.

In the illustrated embodiment, monitor 10 further includes another swivel lock 38. This mechanism includes a threaded shaft (not shown) fixed to the external handle. The shaft is rotatably supported by a housing mounted to intermediate section 14. A threaded brake shoe (not shown) engages the threads of the shaft. As the handle of swivel lock 38 is rotated in one direction, the threaded engagement draws the brake shoe against inlet section 12 which effectively locks rotation via friction. If the handle is rotated in the opposite direction, the threaded engagement draws the brake shoe away from inlet section 12 to again permit rotation. Monitor 10 may include swivel locks 38 or swivel locks 32, or may include a combination of such swivel locks, or may include another suitable swivel lock mechanism.

In addition, a downstream pivot adjuster 39, commonly referred to as a “tiller bar,” is provided to allow a user to pivot outlet section 16 with respect to intermediate section 14 and inlet section. Other pivot adjustment systems and mechanisms, including electronic systems, may of course be used in connection with monitor 10, as required or desired for a particular application.

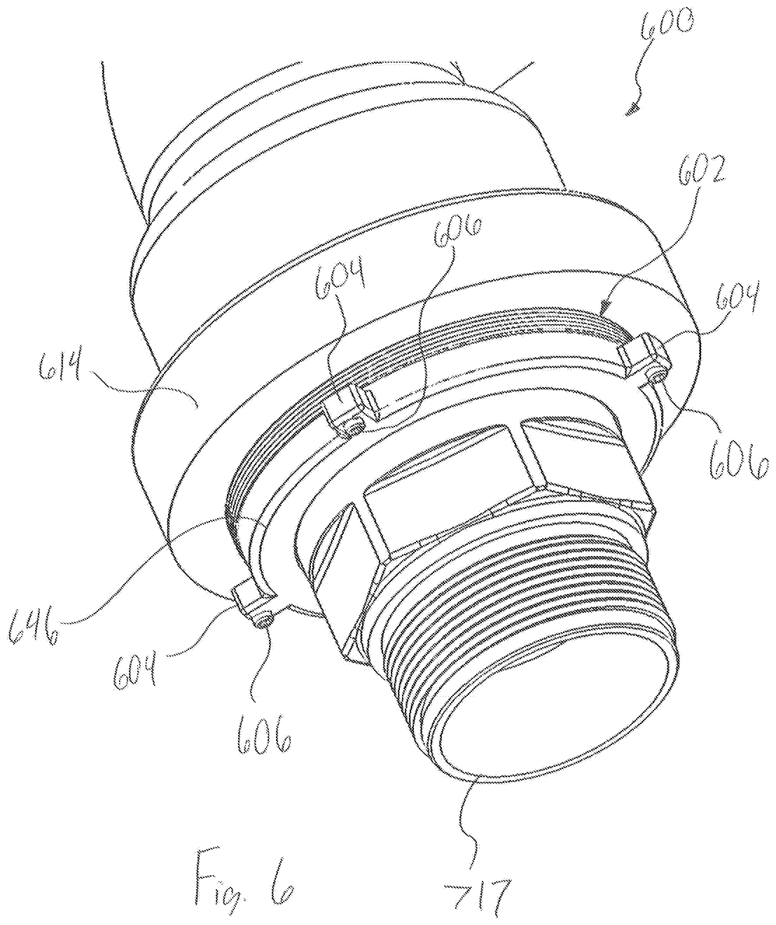

Referring now to FIG. 6, yet another embodiment of a pivot connection 600 is illustrated. In the embodiment of FIG. 6, a retainer 646 may be threadably coupled directly to another section such as section 614. Section 614 may be the intermediate section 14 or the outlet section 16. Further still, section 614 may be any fluid piping that exits a pivot connection and this disclosure contemplates many different applications of the pivot connection 600. More specifically, in the configuration of FIG. 6, the retainer 646 has a threaded portion 602 on a radially outer surface thereof. The threaded portion 602 may correspond with a threaded portion of section 614 to allow the retainer 646 to be threadably coupled directly to section 614.

In one aspect of this disclosure, the retainer 646 may have one or more lug 604 extending radially away from a central axis of the retainer 646. The one or more lug may provide a location to rotationally lock a tool or the like to allow the retainer 646 to be threadably coupled to the section 614 at a desired torque. In one aspect of this disclosure, four lugs 604 may be equally spaced about the axis of the retainer 646. However, other embodiments may have fewer or more than four lugs 604. Alternatively, a recess may be defined in the retainer 646 to rotationally lock a tool thereto.

The retainer 646 may also have one or more setscrew 606 positioned therein. The setscrews 606 may be repositionable through the retainer to contact section 614. In one non-exclusive example, the setscrews 606 may be positionable in threaded through holes defined through the lugs 604. However, in other embodiments the setscrews 606 are defined through threaded through holes on other portions of the retainer 646. Regardless of their precise location, the setscrews 606 may selectively lock rotation of the retainer 646 relative to the section 614. More specifically, the setscrews 606 may be in a retracted position while the tool us used to rotate and tighten the retainer 646 to the section 614. However, once the retainer 646 is ideally tightened to the section 614, the setscrews 606 may be tightened to contact the section 614. The setscrews 606 may be tightened with a torque sufficient to substantially lock rotation of the retainer 646 relative to the section 614. In other words, the setscrews 606 frictionally lock the retainer 646 to section 614.

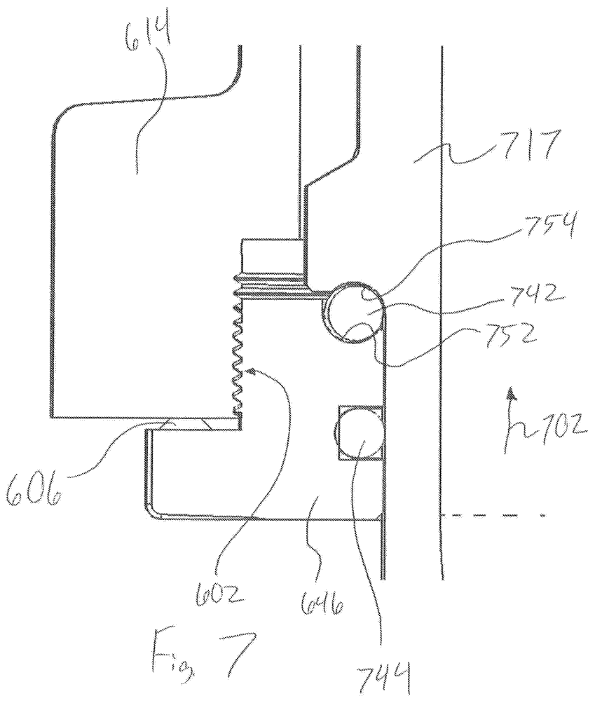

Referring now to FIG. 7, a partial section view of the pivot connection 600 from FIG. 6 is illustrated. More specifically, the retainer 646 is illustrated threadably coupled to section 614 and positioning a bearing 742 between an outboard bearing seat 752 defined in the retainer 646 and an inboard bearing seat 754 defined in a section 717. In this configuration, the bearing 742 may allow section 614 to rotate relative to section 717. Further, with the exception of the different coupling method of the retainer 646, the bearing 742 and bearing seats 752, 754 may be dimensioned and function in substantially the same way as the embodiments discussed herein with reference to FIGS. 1-5.

In one aspect of the embodiment of FIGS. 6 and 7, the retainer 646 may be tightened by rotating the retainer 646 relative to section 614 to thereby apply a compressive load to the bearing 742 in an axial direction 702. In this configuration, the torque applied to the lugs 604 by the tool affects the compressive load applied to the bearing 742 in the axial direction 702. Accordingly, specific tightening instructions may be provided to ensure the bearing 742 is experiencing the desired compressive load. Tightening instructions may include torque values to be applied by the tool to the retainer 646 as well as instructions to backout the retainer 646 a predefined rotational amount after a desired torque was applied, among other things.

In another aspect of this disclosure, the retainer 646 may also define a channel for an O-ring 744 therein. The channel may be sized to correspond with the O-ring 744 to allow section 717 to pivot relative to the retainer 646 with the O-ring 744 positioned therein to prevent debris and the like from contacting the bearing 742.

Also illustrated in FIG. 7 is the setscrew 606 extending through the retainer 646 and contacting section 614. As discussed herein, the setscrew 606 applies a force in the axial direction 702 to substantially frictionally restrict the retainer 646 from rotating relative to section 614 until the setscrew 606 is loosened.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

What is claimed is:

1. A firefighting monitor comprising:
a first section;
a second section joined to the first section by a first pivot connection; and
a plurality of bearings positioned in the first pivot connection between a pair of bearing seats;
wherein, the bearing seats define an arc of contact with each of the plurality of bearings, the center of the arc of contact defining a tangent angled with respect to a flow axis defined by the first pivot connection.

2. The firefighting monitor of claim 1, further comprising a third section joined to the second section by a second pivot connection.

3. The firefighting monitor of claim 2, wherein the first pivot connection defines a first pivot axis, and the second pivot connection defines a second pivot axis substantially perpendicular to the first pivot axis.

4. The firefighting monitor of claim 2, including a second plurality of bearings disposed between a pair of bearing seats of the second pivot connection, the bearing seats defining an arc of contact with each of the second plurality of bearings, the center of the arc of contact defining a tangent angled with respect to a flow axis defined by the second pivot connection.

5. A pivoting joint for conduit, comprising:
a first section defining a flow path for a fluid along an axis and a first bearing seat defined around the axis;
a second section defining a flow path for a fluid along the axis and a second bearing seat defined around the axis; and
a first bearing positioned between the first bearing seat and the second bearing seat;
wherein, the first bearing directly contacts the first section and second section.

6. The pivoting joint of claim 5, further wherein the first section is an inlet to a firefighting monitor and the second section is an intermediate section of the firefighting monitor.

7. The pivoting joint of claim 5, further comprising:
a retainer removably coupled to the first section;
a third bearing seat defined in the second section;
a fourth bearing seat defined in the retainer; and
a second bearing positioned between the third bearing seat and the fourth bearing seat.

8. The pivoting joint of claim 7, further wherein the retainer and first section have threaded portions that correspond with one another and the retainer is threadably coupled directly to the first section.

9. The pivoting joint of claim 8, further wherein the second bearing directly contacts the third bearing seat and the fourth bearing seat.

10. The pivoting joint of claim 8, further wherein the first bearing seat is formed of the same material as the first section.

11. The pivoting joint of claim 8, further comprising:
a first seal channel defined in the first section with a first seal positioned therein; and
a second seal channel defined in the retainer with a second seal positioned therein.

12. The pivoting joint of claim 11, further wherein the first seal fluidly seals the first bearing from the flow path and the second seal prevents debris from contacting the second bearing.

13. The pivoting joint of claim 5, further comprising a seal channel defined in the first section and a seal positioned therein.

14. The pivoting joint of claim 13, further wherein the seal fluidly seals the first bearing from the flow path.

15. The pivoting joint of claim 5, further wherein the second section contains a subsection that is removable from the second section.

16. The pivoting joint of claim 15, further wherein the second bearing seat is defined in the subsection.

17. The pivoting joint of claim 5, further comprising a locking mechanism that selectively locks rotation of the second section relative to the first section.

18. A method of assembling bearings of a firefighting monitor, comprising:
providing a first section of conduit, a second section of conduit, a retainer, and a plurality of bearings;
positioning the plurality of bearings along a first bearing seat defined in the first section of conduit;
axially aligning the second section of conduit with the first section of conduit;
sliding a portion of the second section of conduit into the first section of conduit until a second bearing seat defined in the second section of conduit contacts the plurality of bearings; and
coupling the retainer to the first section of conduit to substantially axially lock the second section of conduit to the first section of conduit;
wherein, when the retainer is coupled to the first section of conduit the second section of conduit rotates relative to the first section of conduit.

19. The method of claim 18, further comprising positioning a first O-ring between the first section of conduit and the second section of conduit to fluidly seal the plurality of bearings from a flow path defined through the first and second section of conduit.

20. The method of claim 19, further wherein the retainer is threadably coupled directly to the first section of conduit.
